(19) United States
(12) Patent Application Publication
(10) Pub. No.: US 2019/0208464 A1
(43) Pub. Date: Jul. 4, 2019

(54) ENHANCED SCANNING FOR MULTI-BAND ACCESS POINTS

(71) Applicant: QUALCOMM Incorporated, San Diego, CA (US)

(72) Inventors: Hoon Ki Lee, San Jose, CA (US); Ravi Kumar Konda, San Jose, CA (US); Suresh Kumar Bitra, Mangalagiri (IN); Manohar Kandagadla, Hyderabad (IN)

(21) Appl. No.: 15/857,534

(22) Filed: Dec. 28, 2017

(51) Int. Cl. H04W 48/16; H04W 84/12; H04W 88/06; H04W 72/04

(52) U.S. Cl. CPC H04W 48/16; H04W 72/0446; H04W 88/06; H04W 84/12

(57) ABSTRACT

This disclosure provides systems, methods, and apparatus, including computer programs encoded on computer storage media, for performing an enhanced network scan. In one aspect, during a network scan of a first frequency band, a station (STA) may provide a probe request to an access point (AP) of a communication network via the first frequency band. The probe request may indicate the STA supports communications in both the first frequency band and a second frequency band. Based on a probe response received from the AP, the STA may determine whether the AP supports communications in both the first frequency band and the second frequency band. The STA may determine to terminate the network scan without scanning the second frequency band in response to determining that the AP supports communications in both the first frequency band and the second frequency band.

### TECHNICAL FIELD

This disclosure relates generally to the field of communication systems, and more particularly to enhanced scanning for multi-band access points (APs) in a communication network.

### DESCRIPTION OF THE RELATED TECHNOLOGY

An access point (AP) of a wireless local area network (WLAN) can enable wireless network access for one or more stations (STAs). The AP may provide a wireless coverage area used by one or more STAs to access the WLAN via the AP. The wireless coverage area provided by the AP may utilize at least a portion of one or more frequency bands (such as a 2.4 GHz frequency band, a 5 GHz frequency band, etc.). Each frequency band may include multiple channels. Within each frequency band supported by the AP, the AP may utilize an operating channel to provide wireless network access for the coverage area.

A STA may perform a network scan to identify all available APs and determine which available AP to associate with in order to join the WLAN and obtain wireless network access. During a traditional network scan, the STA typically scans every channel of each frequency band that is supported by the STA to identify all of the available APs. For example, if the STA supports a 2.4 GHz band and a 5 GHz band, the STA may scan every channel of the 2.4 GHz band and every channel of the 5 GHz band. Scanning all of the channels of every frequency band that is supported by the STA is time-consuming and may consume a significant amount of power, especially if the STA is a battery-powered STA. Also, if multiple STAs perform the network scan concurrently, the messages that are exchanged between the STAs and the APs during a traditional network scan may significantly increase the network traffic within the WLAN, which may lead to network congestion.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a station (STA) for network communication. The STA may provide, during a network scan of a first frequency band, a probe request to an access point (AP) of a network via the first frequency band. The probe request may indicate the STA supports communications in both the first frequency band and a second frequency band. The STA may receive a probe response from the AP via the first frequency band. The STA may determine, based on the probe response received from the AP during the network scan of the first frequency band, whether the AP supports communications in both the first frequency band and the second frequency band. The STA may determine to terminate the network scan without scanning the second frequency band in response to determining that the AP supports communications in both the first frequency band and the second frequency band.

In some implementations, the STA may determine to establish a wireless association with the AP. The STA may determine to terminate the network scan without scanning the second frequency band in response to determining that the AP supports communications in both the first frequency band and the second frequency band, and determining to establish the wireless association with the AP.

In some implementations, the STA may determine a first operating channel of the AP for the first frequency band and a second operating channel of the AP for the second frequency band from the probe response received from the AP during the network scan of the first frequency band and without scanning the second frequency band. The STA may establish a wireless association with the AP via either the first operating channel for the first frequency band or the second operating channel for the second frequency band.

In some implementations, the STA may determine to establish the wireless association with the AP via the second operating channel for the second frequency band. The STA may establish the wireless association with the AP via the second operating channel for the second frequency band without having scanned the second frequency band.

In some implementations, the probe request may include a first multi-band indicator that indicates the STA supports communications in multiple frequency bands, the multiple frequency bands including at least the second frequency band in addition to the first frequency band. The probe response may include a second multi-band indicator that indicates the AP supports communications in multiple frequency bands and frequency band information that specifies the AP supports communications in both the first frequency band and the second frequency band.

In some implementations, the STA may determine that the AP supports communications in both the first frequency band and the second frequency band based, at least in part, on determining the probe response includes the second multi-band indicator and determining the frequency band information from the probe response specifies the AP supports communications in both the first frequency band and the second frequency band.

In some implementations, the STA may determine AP-related information from the probe response received from the AP. The STA may determine the AP supports communications in both the first frequency band and the second frequency band based, at least in part, on the AP-related information. The STA may determine the AP-related information meets an association criteria for establishing a wireless association. The STA may determine to establish the wireless association with the AP in response to determining that the AP-related information meets the association criteria and determining that the AP supports communications in both the first frequency band and the second frequency band.

In some implementations, the AP-related information includes a media access control (MAC) identifier (ID), a plurality of service set (SS) IDs, AP rates and capabilities, a plurality of frequency bands supported by the AP, and a plurality of operating channels associated with the plurality of frequency bands.

In some implementations, the STA may update a scan cache with information associated with the second frequency band obtained from the probe response that was received from the AP during the network scan of the first frequency band and without having scanned the second frequency band.

In some implementations, the probe request may indicate the STA also supports communications in a third frequency band. The STA may determine the AP supports communications in the third frequency band from the probe response received from the AP. The STA may determine to establish a wireless association with the AP. The STA may determine to terminate the network scan without scanning the second frequency band and the third frequency band in response to determining that the AP supports communications in the first frequency band, the second frequency band, and the third frequency band, and determining to establish the wireless association with the AP.

In some implementations, the STA may receive, prior to providing the probe request, a beacon message from the AP via the first frequency band. The beacon message may include an indication that the AP supports both the first frequency band and the second frequency band. The STA may provide the probe request to the AP via the first frequency band in response to receiving the beacon message from the AP via the first frequency band.

In some implementations, the STA may determine the probe response includes an indication that the AP supports Fine Timing Measurement (FTM) for optimized wireless local area network (WLAN) positioning of the STA. The STA may determine to perform a WLAN positioning operation with the AP for the STA via the first frequency band. The STA may determine not to perform the WLAN positioning operation with the AP via the second frequency band.

Another innovative aspect of the subject matter described in this disclosure can be implemented in a STA comprising a processor and memory having instructions stored therein which, when executed by the processor, may cause the STA to provide, during a network scan of a first frequency band, a probe request to an AP of a network via the first frequency band. The probe request may indicate the STA supports communications in both the first frequency band and a second frequency band. The instructions, when executed by the processor, may further cause the STA to receive a probe response from the AP via the first frequency band, determine, based on the probe response received from the AP during the network scan of the first frequency band, whether the AP supports communications in both the first frequency band and the second frequency band, and determine to terminate the network scan without scanning the second frequency band in response to a determination that the AP supports communications in both the first frequency band and the second frequency band.

Another innovative aspect of the subject matter described in this disclosure can be implemented in a STA comprising means for providing, during a network scan of a first frequency band, a probe request to an AP of a network via the first frequency band. The probe request may indicate the STA supports communications in both the first frequency band and a second frequency band. The STA may further comprise means for receiving a probe response from the AP via the first frequency band, means for determining, based on the probe response received from the AP during the network scan of the first frequency band, whether the AP supports communications in both the first frequency band and the second frequency band, means for determining, based on the probe response, whether to establish a wireless association with the AP, and means for determining to terminate the network scan without scanning the second frequency band in response to determining that the AP supports communications in both the first frequency band and the second frequency band and determining to establish the wireless association with the AP.

Another innovative aspect of the subject matter described in this disclosure can be implemented by an AP of a network for network communication. The AP may broadcast a beacon message to the network via a first frequency band. The beacon message may include a first multi-band indicator indicating the AP supports communications in multiple frequency bands. The AP may receive a probe request from a station (STA) via the first frequency band during a network scan. The AP may determine whether the STA supports communications in multiple frequency bands based on whether the probe request includes a second multi-band indicator indicating the STA supports communications in multiple frequency bands. The AP may generate a probe response that includes the first multi-band indicator and frequency band information specifying the AP supports communications in the first frequency band and a second frequency band in response to determining the STA supports communications in multiple frequency bands. The AP may provide the probe response to the STA via the first frequency band.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example diagram of a WLAN including an AP and a STA that can implement the enhanced scanning process.

FIG. 2 depicts a conceptual diagram of an example probe request.

FIG. 3 depicts a conceptual diagram of an example probe response.

FIG. 4 shows an example message flow diagram of a STA and an AP implementing the enhanced active scanning process.

FIG. 5 shows an example flowchart of a STA implementing an enhanced active scanning process.

FIG. 6 shows an example message flow diagram of an AP and a STA implementing the enhanced passive scanning process.

FIG. 7 shows an example flowchart of an AP implementing an enhanced passive scanning process.

FIG. 8 shows an example message flow diagram of a single-band AP and a single-band STA exchanging messages to establish a wireless association.

FIG. 9 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

A network in a home, apartment, business, or other area may include one or more access points (APs) that create a local area network. The local area network (LAN) (sometimes also referred to as a wireless local area network, or WLAN) may provide access to a broadband network. A gateway device, such as a central access point (CAP) or router, may provide access to the broadband network. For example, the gateway device can couple to the broadband network through a cable, a fiber optic, a power line, or digital subscriber line (DSL) network connection. Stations (STAs) in the network can establish a wireless association (also referred to as a wireless link, wireless connection, or the like) with an AP to access the broadband network via the gateway device. The wireless association may be in accordance with an association protocol of the AP (such as an association protocol defined in the IEEE 802.11 standards). The AP may operate on an operating channel within one or more frequency bands. Each frequency band may include multiple channels, and the AP may select one of the channels as the operating channel for the AP. The AP may use the operating channel to communicate with the STAs that have a wireless association with the AP. Similarly, the STAs that have a wireless association with the AP may utilize the operating channel to communicate with the AP.

In order to establish a wireless association with an AP, a STA may perform a network scan to identify one or more available APs of the WLAN. The STA may perform either an active network scan or a passive network scan.

During a traditional active network scan, a STA tunes to a first channel of a first frequency band, sends a message (such as a probe request message) via the first channel, and waits for a period of time to receive a response (such as a probe response message) from an AP on the first channel. The STA then switches to another channel of the first frequency band and performs the same scan process (probe request, and wait for probe response). The STA typically performs the same scan process for all channels of the first frequency band. Also, when the STA is a multi-band STA that supports two or more frequency bands, the STA typically repeats the same scan process for every channel of each of the supported frequency bands. For example, if the STA supports both the first frequency band (such as a 2.4 GHz band) and a second frequency band (such as a 5 GHz band), the STA may perform the scan process for every channel of the 2.4 GHz band and every channel of the 5 GHz band.

During a traditional passive network scan, a STA tunes to a first channel of a first frequency band, and monitors the first channel for a period of time to attempt to receive a beacon message from an AP that may be operating on the first channel. The period of time the STA monitors the channel may be based on a typical beacon interval of WLAN APs, as defined by the IEEE 802.11 standards. According to the 802.11 standards, each AP is configured to periodically generate and transmit beacon messages every beacon interval to advertise its presence, capabilities and other AP-related information. When the STA receives a beacon message from an AP, the STA stores the capabilities and other AP-related information included in the beacon message regarding the AP. Then, the STA switches to another channel of the first frequency band and performs the same scan process (monitor and wait for a beacon message). As with active network scanning, during a passive network scan the STA typically performs the same scan process for all channels of the first frequency band. Also, when the STA is a multi-band STA that supports two or more frequency bands, the STA typically repeats the same scan process for every channel of each of the supported frequency bands.

Performing the traditional active scan or traditional passive scan processes for every channel of each of the supported frequency bands is generally time-consuming and power consuming, especially for battery-powered STAs. Also, if multiple STAs (and APs) are performing the scan process concurrently for multiple frequency bands, the WLAN can become congested via the multitude of probe requests, probe responses, and beacon messages. Furthermore, the number of probe requests, probe responses, and beacon messages that are sent within the WLAN increases due to a higher number of frequency bands supported by the STAs and APs. In accordance with this disclosure, these potential disadvantages of traditional active and passive scanning processes may be overcome by an enhanced scanning process that can be implemented by multi-band STAs and APs.

In some implementations, during an enhanced active scanning process, a STA that supports two or more frequency bands (such as the 2.4 GHz band, the 5 GHz band, and the 60 GHz band) may provide a probe request to an AP of the WLAN via a first frequency band (such as the 2.4 GHz band). The probe request may include an indication that the STA supports communications in two or more frequency bands and supports an enhanced scanning process. The probe request may include one or more bits (such as in a vendor-specific information element of the probe request) that indicate the STA is a multi-band STA that supports the enhanced scanning process. For example, the STA may support communications in the first frequency band (such as the 2.4 GHz band) and a second frequency band (such as the 5 GHz band). The STA may receive a probe response from the AP via the first frequency band. Based on the received probe response, the STA may determine whether the AP supports the enhanced scanning process and whether the AP supports communications in the two or more frequency bands that are supported by the STA. For example, the probe response may include an indication that the AP supports the enhanced scanning process, and also may include an indication that the AP supports the first frequency band and the second frequency band. Also, the probe response may include information associated with the supported frequency bands and other AP-related information that the STA can use to determine whether to establish a wireless association with the AP. If the STA determines that the AP supports communications in the first frequency band and a second frequency band, the STA may terminate the network scan without scanning the second frequency band. The STA may then initiate the association process to establish a wireless association with the AP via the first frequency band or the second frequency band.

In some implementations, during an enhanced passive scanning process, the STA may receive a beacon message from the AP via the first frequency band. The beacon message may include an indication that the AP supports communications in two or more frequency bands and supports the enhanced scanning process. For example, the beacon message may include one or more bits (such as in a vendor-specific information element of the beacon message) that indicate the AP is a multi-band AP that supports the enhanced scanning process. Based on the beacon message, the STA may determine whether the AP is a multi-band AP that supports the enhanced scanning process. If so, the STA may provide a probe request to the AP via the first frequency band, and the AP may respond with a probe response. The probe request and probe response messages that are exchanged during the enhanced passive scanning process are similar to the probe request and probe response messages that were described for the enhanced active scanning process. Based on the received probe response, if the STA determines that the AP supports communications in the first frequency band and a second frequency band, the STA may terminate the network scan early without scanning the second frequency band. The STA may then initiate the association process to establish a wireless association with the AP via the first frequency band or the second frequency band.

Particular implementations of the subject matter described in this disclosure can be implemented to realize one or more of the following potential advantages. The enhanced scanning process may reduce the amount of time the STA spends scanning the frequency bands of the WLAN. For example, if the STA determines while scanning the first frequency band that an AP supports both the first frequency band and the second frequency band, the STA may terminate the network scanning early without scanning the second frequency band at all. When the STA and the AP support the same three frequency bands (such as the 2.4 GHz band, the 5 GHz band, and the 60 GHz), the STA may terminate the network scanning early without scanning two of the three frequency bands. In addition to efficiently performing the network scan, the STA also may conserve power by reducing the amount of time the STA spends scanning the frequency bands of the WLAN. Furthermore, since the STA terminates the network scan early without scanning one or more frequency bands, the enhanced scanning process may substantially reduce the number of probe requests, probe responses, and beacon messages that are sent in the WLAN. Thus, the enhanced scanning process may reduce network traffic and help prevent network congestion.

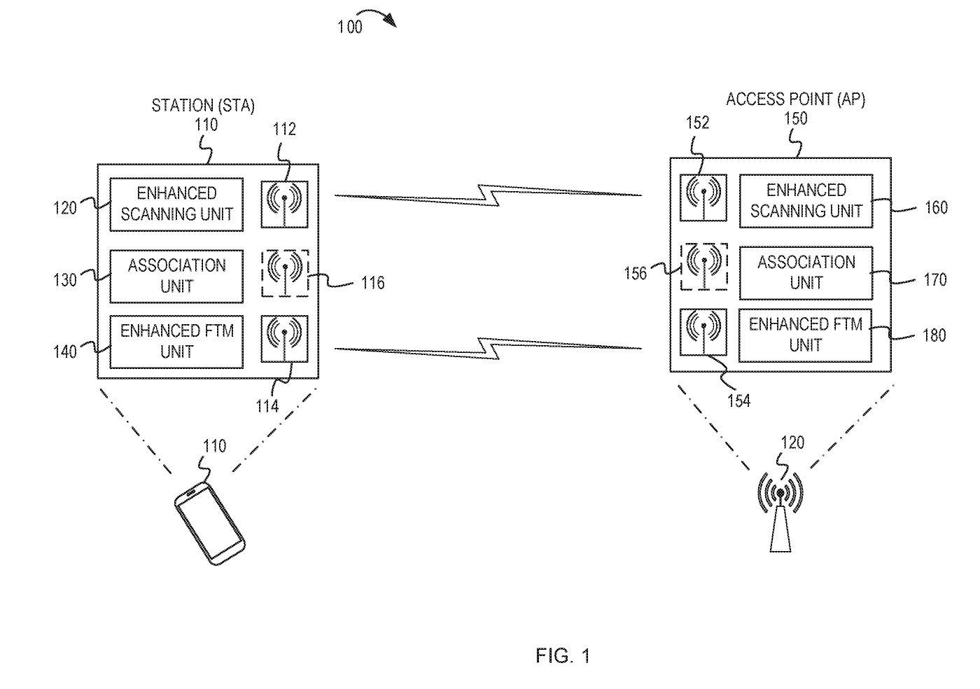

FIG. 1 shows an example diagram of a WLAN including an AP and a STA that can implement the enhanced scanning process. The WLAN 100 may include at least a STA 110 and an AP 150. The STA 110 may be one of various types of multi-band STAs that can support multiple frequency bands. For example, the STA 110 may be a mobile phone, a tablet computer, a laptop computer, a wearable device, or the like, that includes a WLAN modem (or multiple WLAN modems) that supports communications in multiple frequency bands. As illustrated, the STA 110 may include a network interface 112, a network interface 114, an optional network interface 116, an enhanced scanning unit 120, and an association unit 130. The network interfaces 112, 114, and 116 may be included in a communication module of the STA 110 and are representative of the one or more modems, one or more antennas, analog front end (AFE), and other communication-related components of the STA 110. The enhanced scanning unit 120 and the association unit 130 also may be included in the communication module of the STA 110 and, in some implementations, may be implemented by one or more processors of the communication module. In some implementations, the STA 110 may use the network interface 112 to communicate via a first frequency band (such as the 2.4 GHz band), the network interface 114 to communicate via a second frequency band (such as the 5 GHz band), and the optional network interface 116 (if available) to communicate via a third frequency band (such as the 60 GHz band). The STA 110 may use the enhanced scanning unit 120 and the association unit 130 to implement the enhanced scanning process.

The AP 150 may be a multi-band AP that includes a WLAN modem (or multiple WLAN modems) that supports communications in multiple frequency bands. As illustrated, the AP 150 may include a network interface 152, a network interface 154, an optional network interface 156, an enhanced scanning unit 160, and an association unit 170. The network interfaces 152, 154, and 156 may be included in a communication module of the AP 150 and are representative of the one or more modems, one or more antennas, analog front end (AFE), and other communication-related components of the AP 150. The enhanced scanning unit 160 and the association unit 170 also may be included in the communication module of the AP 150 and, in some implementations, may be implemented by one or more processors of the communication module. In some implementations, the AP 150 may use the network interface 152 to communicate via a first frequency band (such as the 2.4 GHz band), the network interface 154 to communicate via a second frequency band (such as the 5 GHz band), and the optional network interface 156 (if available) to communicate via a third frequency band (such as the 60 GHz band). The AP 150 may use the enhanced scanning unit 160 and the association unit 170 to implement the enhanced scanning process. It is noted that although FIG. 1 shows the STA 110 and AP 150 having two or three network interfaces that support two or three different frequency bands, in some implementations the STA 110 and AP 150 may have more than three network interfaces and support more than three frequency bands.

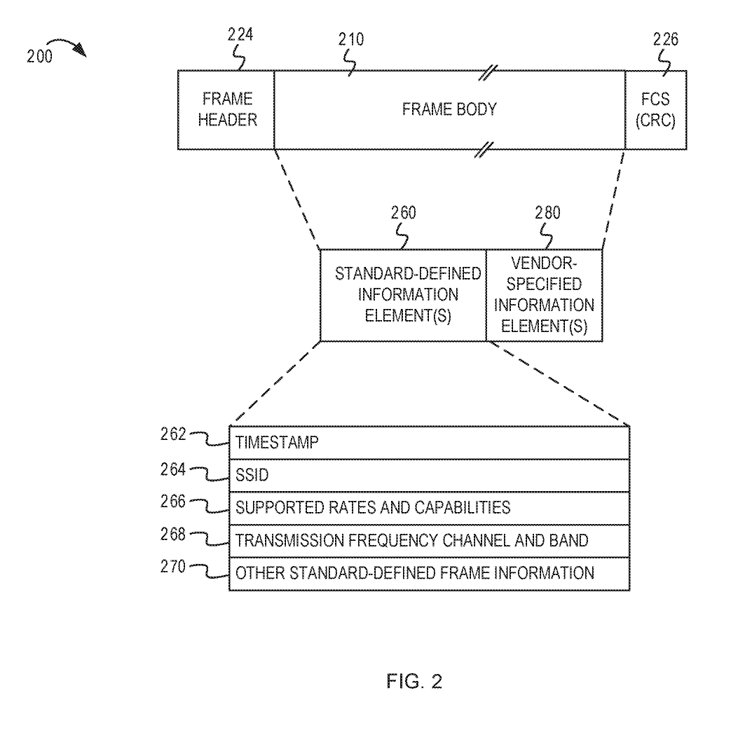

In some implementations, the enhanced scanning unit 120 of the STA 110 may initiate an enhanced active scanning process. For example, the enhanced scanning process may be initiated in response to receiving an input from a user of the STA 110, receiving an instruction from an application running on the STA 110, or detecting network traffic of the WLAN 100. The enhanced scanning unit 120 may generate a probe request for transmission to the AP 150 in the first frequency band (such as the 2.4 GHz band) via the network interface 112. The probe request may include an indication that the STA 110 supports communications in multiple frequency bands and supports the enhanced scanning process (which may be referred to herein as a multi-band indicator). For example, the probe request may include one or more bits (such as in a vendor-specific information element of the probe request) as the multi-band indicator that indicates the STA 110 is a multi-band STA that supports the enhanced scanning process, as will be further described in FIG. 2.

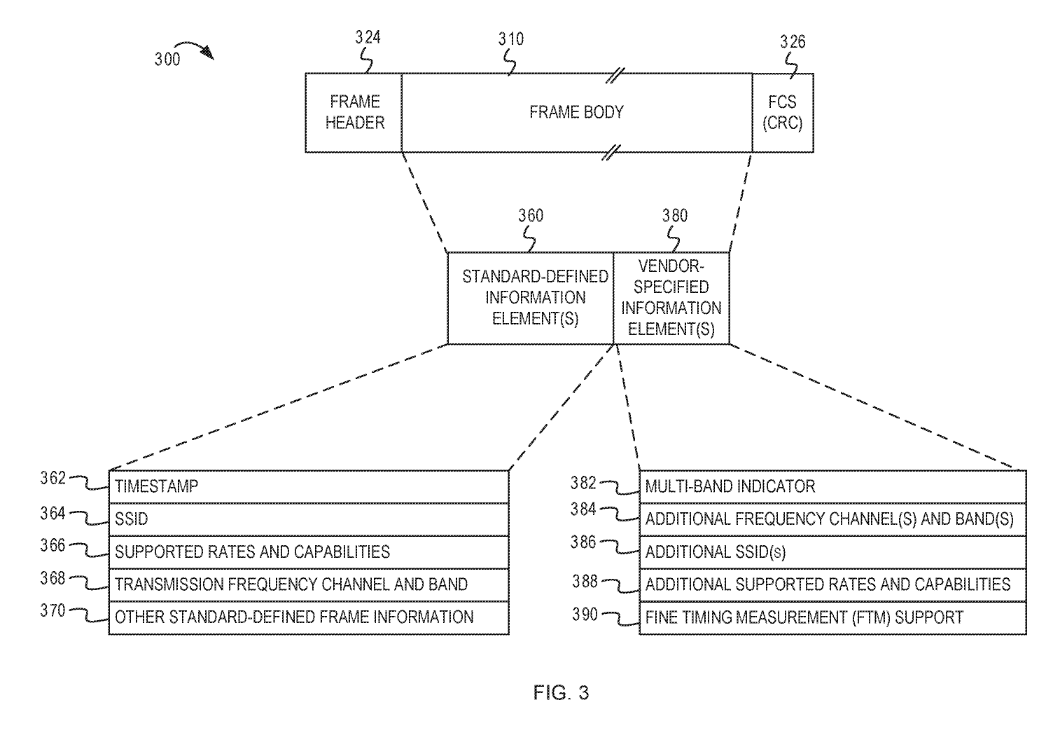

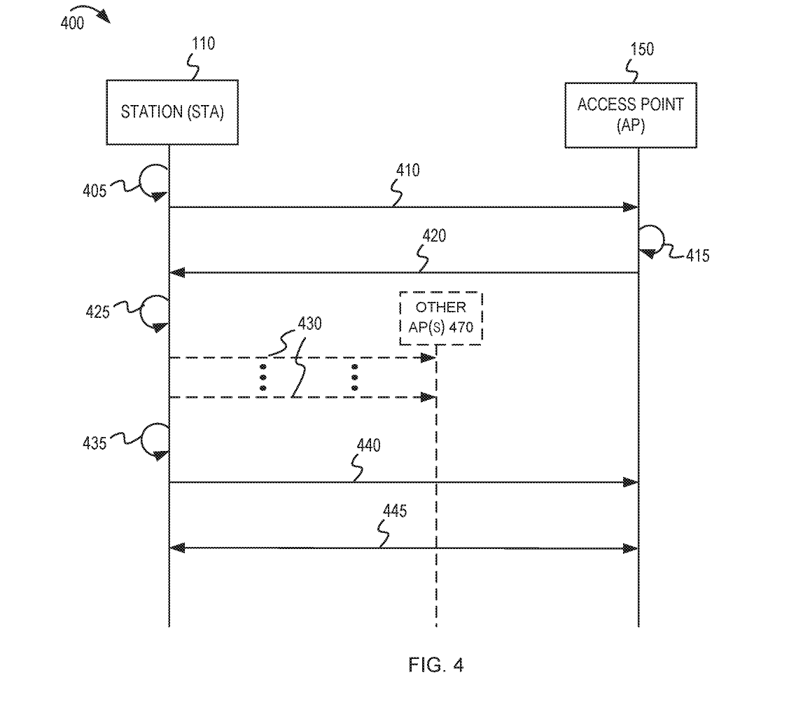

The enhanced scanning unit 120 may receive a probe response from the AP 150 in the first frequency band (such as the 2.4 GHz band) via the network interface 112. For example, the enhanced scanning unit 160 of the AP 150 may generate the probe response for transmission to the STA 110 in the 2.4 GHz band via the network interface 152. The enhanced scanning unit 120 may determine whether the AP 150 supports the enhanced scanning process and whether the AP 150 supports communications in the same frequency bands that are supported by the STA 110 based on the received probe response. For example, the probe response may include one or more bits (such as in a vendor-specific information element of the probe request) as a multi-band indicator that indicates the AP 150 supports the enhanced scanning process. The probe response also may include frequency band information (such as in a vendor-specific information element of the probe request) that indicates the AP 150 supports the 2.4 GHz and 5 GHz bands and also the operating channels within each supported frequency band. In some implementations, the AP 150 also may support the 60 GHz band or other frequency bands. Also, as will be further described in FIGS. 3-4, the probe response may include other network and AP-related information that the STA 110 can use to determine whether to establish a wireless association with the AP 150, such as a media access control (MAC) identifier (ID), basic service set (BSS) IDs, service set (SS) IDs, the IEEE 802.11 standards that are supported by the AP 150, etc. If the enhanced scanning unit 120 determines that the AP 150 supports the enhanced scanning process and supports communications in both the 2.4 GHz and 5 GHz bands, the enhanced scanning unit 120 may terminate the network scan early without scanning the 5 GHz band. The association unit 130 of the STA 110 may then initiate the association process to establish a wireless association with the AP 150 via either the 2.4 GHz band or the 5 GHz band. For example, the association unit 130 of the STA 110 may exchange authentication and association related messages with the association unit 170 of the AP 150 in order to establish the wireless association between the STA 110 and the AP 150.

After determining that the AP 150 supports both the 2.4 GHz and 5 GHz bands, the enhanced scanning unit 120 may store the frequency band information and the other AP-related information that was included in the probe response for further analysis. For example, while scanning the 2.4 GHz band, the enhanced scanning unit 120 may add both the 2.4 GHz band related information and the 5 GHz related information to a scan cache (or other type of memory) of the STA 110. The enhanced scanning unit 120 then may analyze the stored information to determine whether the AP 150 meets an association criteria for establishing a wireless association with the STA 110. The association criteria may be used by the STA to determine whether the frequency band information and the other AP-related information that was included in the AP's probe response is compatible with the STA and meets the operational requirements of the STA, which may indicate whether the AP is a good candidate for establishing the wireless association. The association criteria may specify certain frequency bands, 802.11 standards, and SSID(s), among other criteria, for determining whether to establish the wireless association. For example, to determine whether the AP 150 meets the association criteria, the enhanced scanning unit 120 may determine whether the AP 150 supports both the 2.4 GHz and 5 GHz bands, whether the AP 150 supports certain IEEE 802.11 standards (such as the 802.11ac standard), and whether the AP 150 supports a specific SSID. It is noted that this is just one example association criteria and the enhanced scanning unit 120 of the STA 110 may specify a subset of the criteria described herein, or the STA may have different association criteria. For example, the enhanced scanning unit 120 may determine whether the AP 150 supports three frequency bands (such as the 2.4 GHz, 5 GHz, and 60 GHz bands), whether the AP 150 supports the 802.11ax standard, whether the AP 150 supports at least one of two different SSIDs, and whether the AP 150 supports certain data rates. The enhanced scanning unit 120 of the STA 110 may determine to establish a wireless association with the AP 150 in response to determining that the AP-related information meets the association criteria. In some implementations, before the enhanced scanning unit 120 terminates the network scan early, the association unit 130 may first determine whether the AP 150 meets the association criteria in order to determine the STA 110 will associate with the AP 150. For example, the enhanced scanning unit 120 may terminate the network scan without scanning the 5 GHz band after the enhanced scanning unit 120 determines that the AP 150 supports the enhanced scanning process and supports communications in both the 2.4 GHz and 5 GHz bands, and the association unit 130 determines the AP 150 meets the association criteria.

In some implementations, the enhanced scanning unit 120 of the STA 110 may initiate an enhanced passive scanning process. The enhanced scanning unit 120 may select a first frequency band (such as the 2.4 GHz band) and may begin monitoring the first frequency band for beacon messages. The enhanced scanning unit 120 may receive a beacon message from the AP 150 in the first frequency band (such as the 2.4 GHz band) via the network interface 112. For example, the enhanced scanning unit 160 of the AP 150 may generate the beacon message for transmission in the WLAN 100 in the 2.4 GHz band via the network interface 152. The beacon message may include an indication that the AP 150 supports communications in multiple frequency bands and supports the enhanced scanning process (which may be referred to herein as a multi-band indicator). For example, the beacon message may include one or more bits (such as in a vendor-specific information element of the beacon message) as the multi-band indicator that indicates the AP 150 is a multi-band AP that supports the enhanced scanning process. The enhanced scanning unit 120 may determine whether the AP 150 is a multi-band AP that supports the enhanced scanning process based on the received beacon message. If the enhanced scanning unit 120 determines the AP 150 is a multi-band AP that supports the enhanced scanning process, the enhanced scanning unit 120 may provide a probe request to the AP 150 via the 2.4 GHz band. The AP 150 may then respond with a probe response via the 2.4 GHz band. It is noted that in some implementations the probe request and probe response messages that are exchanged during the enhanced passive scanning process are similar to the probe request and probe response messages that were described for the enhanced active scanning process.

Based on the received probe response, if the STA 110 determines that the AP 150 supports communications in both the 2.4 GHz and 5 GHz bands, the enhanced scanning unit 120 may terminate the network scan without scanning the 5 GHz band. In some implementations the enhanced scanning unit 120 may terminate the network scan without scanning the 5 GHz band after the enhanced scanning unit 120 determines that the AP 150 supports the enhanced scanning process and supports communications in both the 2.4 GHz and 5 GHz bands, and the association unit 130 determines the AP 150 meets the association criteria for establishing a wireless association. After the scanning process is terminated, the association unit 130 may then initiate the association process to establish a wireless association with the AP 150 via the 2.4 GHz band or the 5 GHz band. For example, the association unit 130 of the STA 110 may exchange authentication and association related messages with the association unit 170 of the AP 150 in order to establish the wireless association between the STA 110 and the AP 150.

In some implementations, the STA 110 may initiate a network scan to perform a WLAN positioning operation. During the network scan, in addition to providing information that the AP 150 supports multiple frequency bands, the AP 150 may include in beacon messages and in probe responses an indication that the AP 150 supports Fine Timing Measurement (FTM) for optimized WLAN positioning. When the STA 110 performs a network scan as part of a WLAN positioning operation, the STA 110 may determine from a beacon message or a probe response received from the AP 150 that the AP 150 supports multiple frequency bands and supports FTM. If the STA 110 determines the AP 150 supports multiple frequency bands and supports FTM, the STA 110 may determine to perform round-trip time (RTT) measurements with the AP 150 for WLAN positioning in only one of the supported frequency bands. For example, an enhanced FTM unit 140 of the STA 110 may perform RTT measurements by sending messages to an enhanced FTM unit 180 of the AP 150 via the first frequency band (such as the 2.4 GHz band). The STA 110 does not have to perform RTT measurements with the AP 150 in the other supported frequency bands for WLAN positioning because the different supported frequency bands will have the same WLAN positioning results since it is the same physical AP in the same physical location. Performing WLAN positioning in all of the supported frequency bands will provide duplicate RTT measurements and duplicate WLAN positioning results, and will consume additional power. Thus, WLAN positioning can be optimized (and power can be conserved) by performing the WLAN positioning operations (including RTT measurements) in only one of the supported frequency bands.

FIG. 2 depicts a conceptual diagram of an example probe request. The probe request 200 may be referred to as a probe request message or frame. As described in FIG. 1, a probe request may be used by a STA (such as STA 110) during an enhanced active or passive scanning process. For example, the example probe request 200 may be sent from the STA 110 to the WLAN 100 and received by the AP 150. The example probe request 200 may include a frame header 224, a frame body 210, and a frame check sequence (FCS) 226. The frame header 224 may include source and destination network addresses (such as the network address of the sending STA and receiving AP, respectively), the length of frame, frame control information, a BSSID element, and other frame header information as defined by the IEEE 802.11 standards. The FCS 226 may include error-detecting code that can be used to detect errors or data corruption during the transmission. The frame body 210 may include standard-defined information element(s) 260 and vendor-specific information element(s) 280.

The standard-defined information element(s) 260 of the probe request 200 may be defined by the IEEE 802.11 standards, and may include a timestamp 262, an SSID element 264, supported rates and capabilities element(s) 266, transmit (TX) frequency channel and band element 268, and other frame information 270 as defined by the IEEE 802.11 standards. The vendor-specific information element(s) 280 of the probe request 200 may include any additional frame information that vendors include into their products, which may or may not be specified by the IEEE 802.11 standards. For example, as described in FIG. 1, one or more bits of a vendor-specified information element(s) 280 may be used as a multi-band indicator in the probe request 200 for the enhanced scanning process. In some implementations, to limit the size of the probe request 200, the multi-band indicator that is included in the vendor-specified information element(s) 280 may be a single bit that indicates whether or not the STA 110 supports multiple bands and supports the enhanced scanning process. The multi-band indicator may not specify the additional one or more frequency bands that are supported by the STA 110 (in addition to the frequency band and the corresponding operating channel that is being used to transmit the probe request 200 and specified by the TX frequency channel and band element 268). In some other implementations, the STA 110 may use additional bits from the vendor-specific information element(s) 280 to specify the additional one or more frequency bands or channels that are supported by the STA 110.

FIG. 3 depicts a conceptual diagram of an example probe response. The probe response 300 may be referred to as a probe response message or frame. As described in FIG. 1, a probe response may be used by an AP (such as AP 150) during an enhanced active or passive scanning process. For example, the example probe response 300 may be sent from the AP 150 to the STA 110. The example probe response 300 may include a frame header 324, a frame body 310, and a frame check sequence (FCS) 326. The frame header 324 may include source and destination network addresses (such as the network address of the sending AP and receiving STA, respectively), the length of frame, frame control information, a BSSID element, and other frame header information as defined by the IEEE 802.11 standards. The FCS 326 may include error-detecting code that can be used to detect errors or data corruption during the transmission. The frame body 310 may include standard-defined information element(s) 360 and vendor-specific information element(s) 380. The standard-defined information element(s) 360 and vendor-specific information element(s) 380 may include additional AP-related information that the STA 110 can use to determine whether to establish a wireless association with the AP 150.

The standard-defined information element(s) 360 of the probe response 300 may be defined by the IEEE 802.11 standards, and may include a timestamp 362, an SSID element 364, supported rates and capabilities element(s) 366, transmit (TX) frequency channel and band element 368, and other frame information 370 as defined by the IEEE 802.11 standards. The vendor-specific information element(s) 380 of the probe response 300 may include any additional frame information that vendors include into their products, which may or may not be specified by the IEEE 802.11 standards. For example, the vendor-specific information element(s) 380 may include at least a multi-band indicator 382 and an additional frequency channel(s) and band(s) element 384. As described in FIG. 1, one or more bits of a vendor-specified information element(s) 380 may be used as the multi-band indicator 382 in the probe response 300 for the enhanced scanning process. The additional frequency channel(s) and band(s) element 384 may specify the one or more frequency bands (such as the 5 GHz and 60 GHz bands) and the corresponding operating channels that are supported by the AP 150 (in addition to the frequency band and corresponding operating channel that is being used to transmit the probe response 300 and specified by the TX frequency channel and band element 368). In some implementations, the vendor-specific information element(s) 380 also may include an additional SSID(s) element 386 and an additional supported rates and capabilities element(s) 388 to specify any additional SSIDs, data rates, and capabilities that are associated with the additional one or more frequency channel(s) and band(s) element 384. In some implementations, the vendor-specific information element(s) 380 also may include an FTM support element 390 that indicates whether the AP 150 supports FTM in order to implement an optimized WLAN positioning operation, as described in FIG. 1.

FIG. 4 shows an example message flow diagram of a STA and an AP implementing the enhanced active scanning process. The message flow diagram 400 includes messages between the STA 110 and the AP 150.

At 405, the STA 110 initiates the enhanced active scanning process. For example, the STA 110 may initiate the enhanced scanning process in response to receiving an input from the user of the STA 110, receiving an instruction from an application running on the STA 110, or detecting network traffic of the WLAN 100. For example, the station 110 may begin scanning a first channel of a first frequency band, such as the 2.4 GHz band.

At 410, the STA 110 generates and sends a probe request to the AP 150 via the first channel of the first frequency band. The probe request may include a multi-band indicator that indicates the STA 110 supports communications in multiple frequency bands and supports the enhanced scanning process. For example, the multi-band indicator may be one or more bits in a vendor-specific information element of the probe request (as shown in FIG. 2) and, if present, may indicate the STA supports communications in the first frequency band and at least a second frequency band (such as the 5 GHz band).

At 415, the AP 150 receives and processes the probe request. For example, if the AP 150 supports multiple frequency bands and supports the enhanced scanning process, the AP 150 may determine whether the probe request includes a multi-band indicator. For example, the AP 150 may determine whether any of the vendor-specific information elements of the probe request includes a multi-band indicator in order to determine whether the STA 110 supports communications in multiple frequency bands and supports the enhanced scanning process.

At 420, the AP 150 generates and sends a probe response to the STA 110 via the first channel of the first frequency band. If the AP 150 determines the probe request includes a multi-band indicator, the AP 150 may generate a probe response that includes a multi-band indicator to indicate that the AP 150 also supports multiple frequency bands and supports the enhanced scanning process. For example, the AP 150 may generate and send a probe response that includes one or more bits in a vendor-specific information element of the probe request (as shown in FIG. 3) that indicates the AP 150 supports communications in both the first frequency band (such as the 2.4 GHz band) and the second frequency band (such as the 5 GHz band). The AP 150 also may include frequency band information in the probe response that specifies which frequency bands the AP 150 supports and also the corresponding operating channels associated with the frequency bands. For example, the frequency band information may specify an operating channel of the AP 150 for the first frequency band, and an operating channel of the AP 150 for the second frequency band. Furthermore, the AP 150 may include in the probe response other AP-related information that the STA 110 can use to determine whether to establish a wireless association with the AP 150, such as a MAC ID, BSSIDs, SSIDs, the IEEE 802.11 standards that are supported by the AP 150, etc. If the AP 150 determines the probe request does not include a multi-band indicator, the AP 150 may determine that the STA 110 is a legacy STA that does not support the enhanced scanning process and thus may generate a probe response that does not includes a multi-band indicator.

At 425, the STA 110 receives and processes the probe response. The STA 110 may determine whether the probe response includes a multi-band indicator that indicates the AP 150 supports communications in multiple frequency bands and supports the enhanced scanning process. For example, the STA 110 may determine whether any of the vendor-specific information elements of the probe response includes a multi-band indicator. After determining that the probe response includes the multi-band indicator, the STA 110 may determine from the frequency band information included in the probe response whether the AP 150 supports the same frequency bands as the STA 110. For example, the STA 110 determines whether the AP 150 supports communications in at least the first frequency band and the second frequency band. The STA 110 also may determine the operating channel that is used by the AP 150 for communications in the first frequency band and the operating channel that is used by the AP 150 for communications in the second frequency band. If the AP 150 supports both the first frequency band and the second frequency band, the STA 110 may update a scan cache with both the information associated with the first frequency band and the information association with the second frequency band. For example, the STA 110 may update the scan cache with the operating channel that is used by the AP 150 for communications in the first frequency band and the operating channel that is used by the AP 150 for communications in the second frequency band. With the enhanced scanning process, since the AP 150 may send a probe response that includes information about all of the supported frequency bands, the scan cache can be updated with information regarding the second frequency band without scanning the second frequency band.

Furthermore, the STA 110 may determine whether the AP 150 meets an association criteria for establishing a wireless association with the AP 150 based on the AP-related information that is included in the probe response. The association criteria may be preconfigured by the manufacturer and maybe configurable by the user. For example, as described in FIG. 1, the STA 110 may be configured with association criteria that specifies the STA 110 should establish a wireless association with an AP that supports specific BSSID(s), SSID(s), frequency bands, data rates and capabilities, and IEEE 802.11 standard(s). The STA 110 may determine to establish a wireless association with the AP 150 in response to determining that the AP-related information meets the association criteria. The STA 110 also may determine whether to terminate the active scanning process early without scanning the second frequency band based on whether the AP 150 supports communications in both the first frequency band and the second frequency band, and whether the AP 150 meets the association criteria for establishing the wireless association with the AP 150.

At 430, after the STA 110 sends (at 410) the probe request via the first channel of the first frequency band, the STA 110 continues with the enhanced active scanning process in the first frequency band by sending additional probe requests in other channels of the first frequency band. For example, at 430, additional probe requests may be sent via a second channel of the first frequency band and via a third channel of the first frequency band. The additional probe requests may be received by one or more different APs, such as other AP(s) 470, which may process the additional probe requests (sent at 430) similarly as the AP 150 processed the probe request sent at 410. It is noted that although FIG. 4 shows the additional probe requests being sent at 430, the additional probe requests may be sent any time after 410 and before the scan process is terminated.

At 435, the STA 110 terminates the network scan without scanning the second frequency band in response determining that the AP 150 supports communications in both the first frequency band and the second frequency band, and that the AP 150 meets the STA's association criteria for establishing the wireless association with the STA 110.

At 440, the STA 110 sends an association message to the AP 150 to request the establishment of the wireless association between the STA 110 and the AP 150 via either the first frequency band or the second frequency band. With the enhanced scanning process, since the scan cache is updated with the AP's information regarding both the first frequency band and the second frequency band, the STA 110 can establish a wireless association with the AP 150 using either the operating channel of the first frequency band or the operating channel of the second frequency band, even without having scanned the second frequency band. The STA 110 can select either the first frequency band or the second frequency band for establishing the wireless association based on various factors, such as user input, frequency band preferences specified by an application running in the STA 110, data rates and capabilities associated with each frequency band, available bandwidth, etc. For example, an application running in the STA 110 may specify to use the 5 GHz frequency band (the second frequency band) when available instead of the 2.4 GHz band (the first frequency band). The STA 110 can select the second frequency band for establishing the wireless association even without having scanned the second frequency band.

At 445, the STA 110 and the AP 150 exchange authentication and association related messages in order to establish the wireless association. After the STA 110 and the AP 150 exchange the authentication and association related messages, the wireless association is established and the STA 110 joins the WLAN 100 via the AP 150.

In some implementations, the STA 110 and the AP 150 may support three or more frequency bands. When the STA 110 and the AP 150 support three or more frequency bands, the STA 110 and the AP 150 may perform the same operations described herein when the STA 110 and the AP 150 support two frequency bands. For example, the AP 150 may generate a probe response that indicates the AP 150 supports a third frequency band (such as the 60 GHz band). The STA 110 may determine the AP 150 supports the first frequency band, the second frequency band, and the third frequency band based on the received probe response. The STA 110 may update the scan cache with the frequency band information and the AP-related information associated with the first frequency band, the second frequency band, and the third frequency band. The STA 110 may determine whether to establish a wireless association with the AP 150 based on the association criteria. The STA 110 may determine to terminate the network scan without scanning the second frequency band and the third frequency band in response determining that the AP 150 supports communications in the first frequency band, the second frequency band, and the third frequency band, and determining to establish a wireless association with the AP 150. The STA 110 may then establish the wireless association with the AP 150 via either the first frequency band, the second frequency band, or the third frequency band.

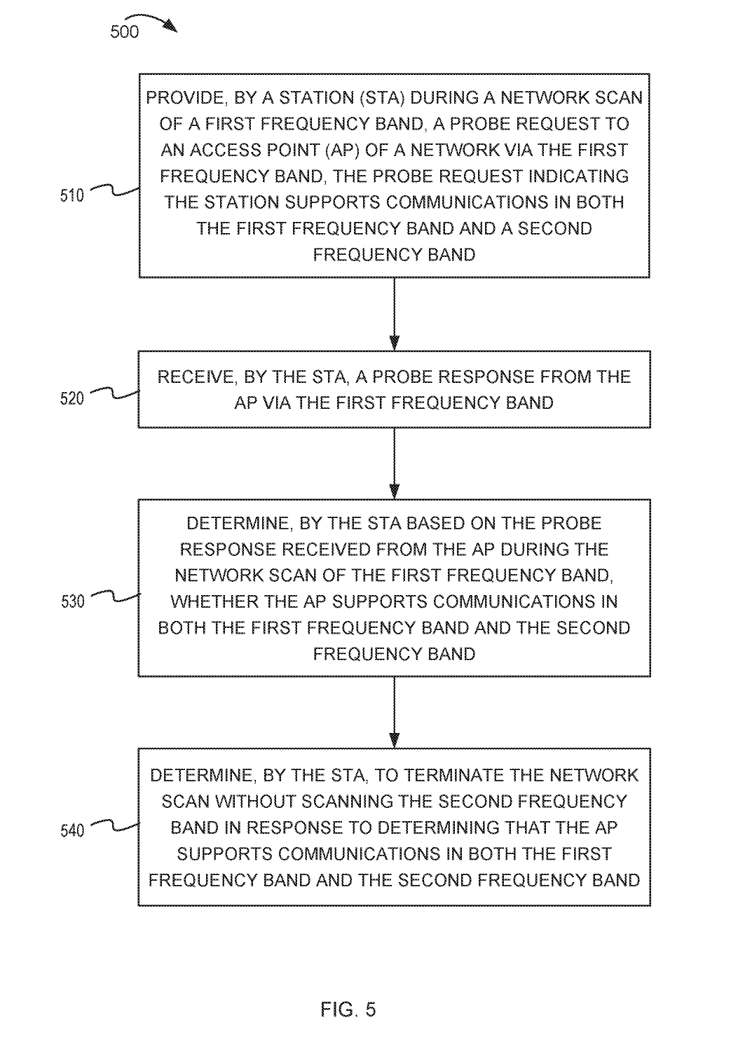

FIG. 5 shows an example flowchart of a STA implementing an enhanced active scanning process. The flowchart 500 begins at block 510.

At block 510, the STA 110 may provide, during a network scan of a first frequency band, a probe request to the AP 150 of the WLAN 100 via the first frequency band. The probe request may indicate the STA 110 supports communications in both the first frequency band and a second frequency band. For example, as described in FIG. 4, the probe request may include a multi-band indicator that indicates the STA 110 supports communications in both the 2.4 GHz band and the 5 GHz band.

At block 520, the STA 110 may receive a probe response from the AP 150 via the first frequency band.

At block 530, the STA 110 determines, based on the probe response received from the AP 150 during the network scan of the first frequency band, whether the AP 150 supports communications in both the first frequency band and the second frequency band.

At block 540, the STA 110 determines to terminate the network scan without scanning the second frequency band in response to determining that the AP 150 supports communications in both the first frequency band and the second frequency. As described in FIGS. 1 and 4, the STA 110 also may determine whether to establish a wireless association with the AP 150 based on whether the AP 150 meets the STA's association criteria for establishing the wireless association. The STA 110 may determine to terminate the network scan without scanning the second frequency band in response to determining that the AP 150 supports communications in both the first frequency band and the second frequency, and determining to establish the wireless association with the AP 150.

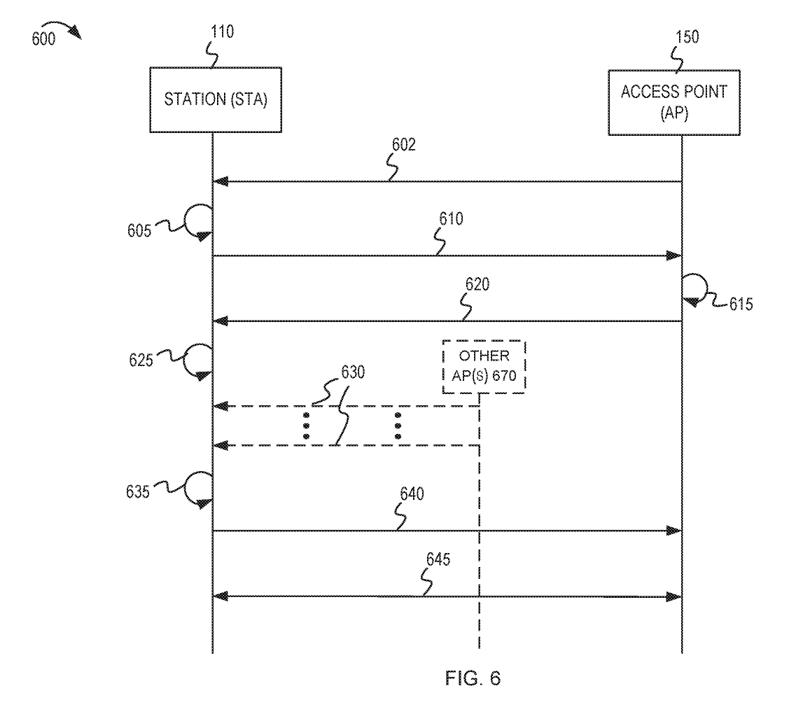

FIG. 6 shows an example message flow diagram of an AP and a STA implementing the enhanced passive scanning process. The message flow diagram 600 includes messages between the AP 150 and the STA 110.

At 602, the AP 150 generates and sends a beacon message via a first channel of a first frequency band. For example, the AP 150 broadcasts the beacon message to the WLAN 100 via the first channel of the first frequency band (such as the 2.4 GHz band). The beacon message may include a multi-band indicator that indicates the AP 150 supports communications in multiple frequency bands and supports the enhanced scanning process. For example, the multi-band indicator may be one or more bits in a vendor-specific information element of the beacon message and, if present, may indicate the AP 150 supports communications in both the first frequency band and at least a second frequency band (such as the 5 GHz band).

At 605, the STA 110 receives and processes the beacon message from the AP 150. The STA 110 may receive the beacon message from the AP 150 via the first channel of the first frequency band while the STA 110 is performing the enhanced passive scanning process. The STA 110 may determine whether the beacon message includes a multi-band indicator that indicates the AP 150 supports communications in multiple frequency bands and supports the enhanced scanning process.

At 610, the STA 110 generates and sends a probe request to the AP 150 via the first channel of the first frequency band. The STA 110 may send the probe request directly to the AP 150 after determining the AP 150 supports communications in multiple frequency bands and supports the enhanced scanning process. The probe request may be similar to the probe request described at block 410 of FIG. 4. The probe request may include a multi-band indicator that indicates the STA 110 supports communications in multiple frequency bands and supports the enhanced scanning process. For example, the multi-band indicator may be one or more bits in a vendor-specific information element of the probe request (as shown in FIG. 2) and, if present, may indicate the STA supports communications in both the first frequency band and at least a second frequency band (such as the 5 GHz band).

At 615, the AP 150 receives and processes the probe request, similarly as described at block 415 of FIG. 4. For example, if the AP 150 supports multiple frequency bands and supports the enhanced scanning process, the AP 150 may determine whether the probe request includes a multi-band indicator.

At 620, the AP 150 generates and sends a probe response to the STA 110 via the first channel of the first frequency band, similarly as described at block 420 of FIG. 4. For example, if the AP 150 determines the probe request includes a multi-band indicator, the AP 150 may generate a probe response that includes a multi-band indicator to indicate that the AP 150 also supports multiple frequency bands and supports the enhanced scanning process. Also, the AP 150 may include frequency band information in the probe response that specifies which frequency bands the AP 150 supports, and may include other AP-related information in the probe response that the STA 110 can use to determine whether to establish a wireless association with the AP 150.

At 625, the STA 110 receives and processes the probe response from the AP 150, similarly as described at block 425 of FIG. 4. For example, the STA 110 may determine whether the probe response includes a multi-band indicator that indicates the AP 150 supports communications in multiple frequency bands and supports the enhanced scanning process, and determine whether the AP 150 supports communications in at least the first frequency band and the second frequency band. If the AP 150 supports both the first frequency band and the second frequency band, the STA 110 may update a scan cache with both the information associated with the first frequency band and the information association with the second frequency band.

Furthermore, similarly as described at block 425 of FIG. 4, the STA 110 may determine whether the AP 150 meets an association criteria for establishing a wireless association with the AP 150 based on the AP-related information that is included in the probe response.

At 630, the STA 110 continues with the enhanced passive scanning process in the first frequency band by listening for beacon messages in other channels of the first frequency band. For example, at 630, additional beacon messages may be received via a second channel of the first frequency band and via a third channel of the first frequency band. The additional beacon messages may be broadcasted by one or more different APs, such as other AP(s) 670. The STA 110 may process the additional beacon messages (received at 630) similarly as the STA 110 processed the beacon message received at 605. It is noted that although FIG. 6 shows the additional beacon messages being received by the STA 110 at 630, the additional beacon messages may be received any time after the STA 110 begins the enhanced passive scanning process and before the scan process is terminated.

At 635, the STA 110 terminates the network scan without scanning the second frequency band in response determining that the AP 150 supports communications in both the first frequency band and the second frequency band, and that the AP 150 meets the STA's association criteria for establishing the wireless association with the STA 110.

At 640, the STA 110 sends an association message to the AP 150 to request the establishment of the wireless association between the STA 110 and the AP 150 via either the first frequency band or the second frequency band, similarly as described at block 440 of FIG. 4.

At 645, the STA 110 and the AP 150 exchange authentication and association related messages in order to establish the wireless association. After the STA 110 and the AP 150 exchange the authentication and association related messages, the wireless association is established and the STA 110 joins the WLAN 100 via the AP 150.

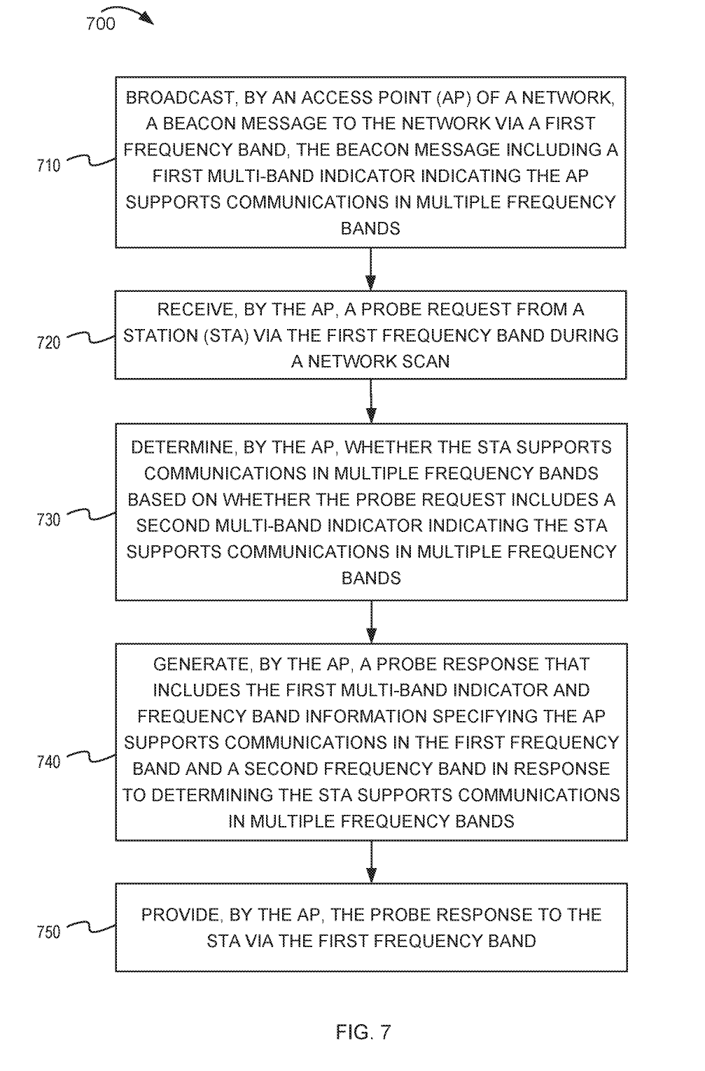

FIG. 7 shows an example flowchart of an AP implementing an enhanced passive scanning process. The flowchart 700 begins at block 710.

At block 710, the AP 150 of the WLAN 110 broadcasts a beacon message to the WLAN 100 via a first frequency band. The beacon message may include a first multi-band indicator indicating the AP 150 supports communications in multiple frequency bands and supports the enhanced scanning process.

At block 720, the AP 150 receives a probe request from the STA 110 via the first frequency band during a network scan.

At block 730, the AP 150 determines whether the STA 110 supports communications in multiple frequency bands based on whether the probe request includes a second multi-band indicator indicating the STA 110 supports communications in multiple frequency bands.

At block 740, the AP 150 generates a probe response that includes the first multi-band indicator and frequency band information specifying the AP 150 supports communications in the first frequency band and a second frequency band in response to determining the STA 110 supports communications in multiple frequency bands.

At block 750, the AP 150 provides the probe response to the STA 110 via the first frequency band. As described in FIG. 6, based on the probe response received from the AP 150, the STA 110 may determine whether the AP 150 supports communications in both the first frequency band and the second frequency band, and whether the AP 150 meets the STA's association criteria for establishing a wireless association with the STA 110.

In some implementations, the STA 110 may perform an optimized WLAN positioning operation with the AP 150. As part of the WLAN positioning operation, the STA 110 may determine whether the beacon message (such as the beacon message received at 605 of FIG. 6) or the probe response (such as the probe response received at 425 of FIG. 4) that was received from the AP 150 indicates that the AP 150 supports multiple frequency bands and supports FTM. As described in FIG. 1, if the STA 110 determines the AP 150 supports multiple frequency bands and supports FTM, the STA 110 may determine to perform RTT measurements with the AP 150 for WLAN positioning in only one of the supported frequency bands. For example, the STA 110 may perform RTT measurements by sending messages to the AP 150 via the first frequency band (such as the 2.4 GHz band). The STA 110 does not have to perform RTT measurements with the AP 150 in the other supported frequency bands for WLAN positioning because the different supported frequency bands will have the same WLAN positioning results since it is the same physical AP in the same physical location. For example, after obtaining the WLAN positioning results with respect to the AP 150 in the first frequency band (such as the 2.4 GHz band), the STA 110 will not perform the WLAN positioning operations with the AP 150 in the second frequency band (such as the 5 GHz band).

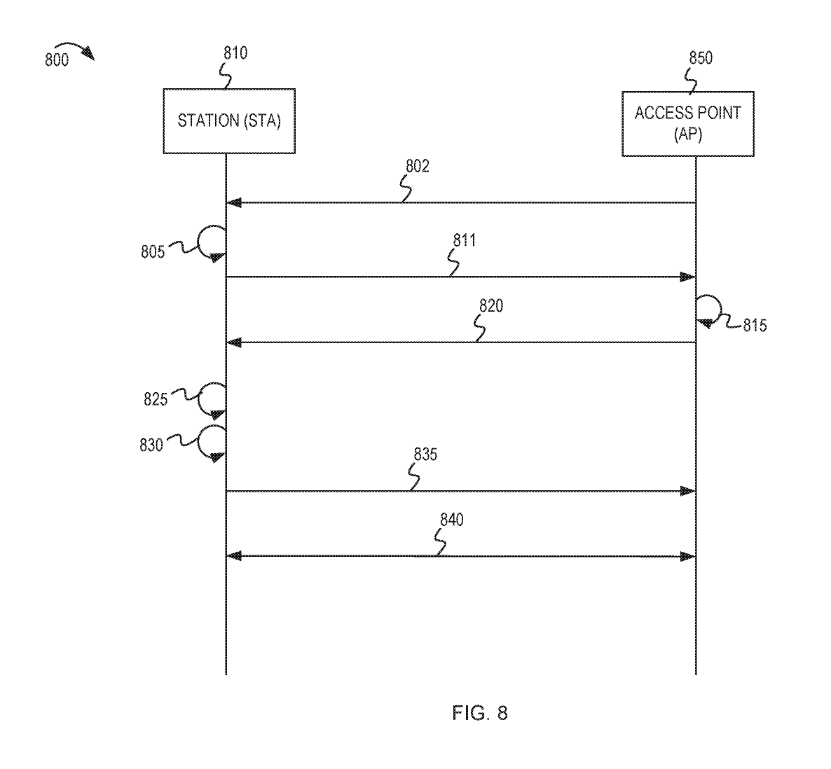

FIG. 8 shows an example message flow diagram of a single-band AP and a single-band STA exchanging messages to establish a wireless association. The message flow diagram 800 includes messages between an AP 850 and an STA 810. Unlike the AP 150 and the STA 110 that are multi-band network devise, the AP 850 and the STA 810 may be network devices of the WLAN 100 that support a single frequency band (such as the 2.4 GHz band or the 5 GHz band). Even though the AP 850 and the STA 810 may support a single frequency band, the AP 850 and the STA 810 may support two or more operating channels within the supported frequency band.

At 802, the AP 850 broadcasts a beacon message to the WLAN 100 via a first channel of a first frequency band (such as the 2.4 GHz band or the 5 GHz band). The beacon message may include an indication that the AP 850 supports the first frequency band and supports multiple operating channels for the first frequency band. For example, the beacon message may include a multi-channel indicator (such as one or more bits in a vendor-specific information element of the beacon message) that indicates the AP 850 supports communications in multiple operating channels for the first frequency band.

At 805, the STA 810 may receive and process the beacon message from the AP 850. The STA 810 may receive the beacon message via the first channel of the first frequency band. The STA 810 may determine that the beacon message includes the multi-channel indicator, and thus may determine that the AP 850 supports multiple operating channels for the first frequency band. For example, the AP 850 may support both the first channel and a second channel of the first frequency band.

At 811, the STA 810 generates and sends a probe request to the AP 850 via the first channel of the first frequency band. The probe request may include a multi-channel indicator that indicates the STA 810 supports a single frequency band (and supports multiple operating channels).

At 815, the AP 850 receives and processes the probe request from the STA 810. Based on the probe request, the AP 850 may determine the STA 810 supports a single frequency band and that it is the same frequency band that is supported by the AP 850.

At 820, the AP 850 generates and sends a probe response to the STA 810 via the first channel of the first frequency band. In addition to the multi-channel indicator, the AP 850 may include frequency channel information in the probe response that specifies which operating channels the AP 850 supports. For example, the frequency channel information may specify that the operating channels supported by the AP 850 are Channel 1 and Channel 11 of the 2.4 GHz band. The probe response also may include other AP-related information that the STA 810 can use to determine whether to establish a wireless association with the AP 850. For example, as described in FIG. 3, the other AP-related information may include a MAC ID, BSSIDs, SSIDs, the IEEE 802.11 standards that are supported by the AP 850, etc.

At 825, the STA 810 receives and processes the probe response from the AP 850. For example, the STA 810 may access the frequency channel information included in the probe response to determine the specific operating channels of the first frequency band that are supported by the AP 850. Similar to the description of FIG. 4, the STA 810 may update a scan cache with the operating channels of the first frequency band that are supported by the AP 850.

Furthermore, similarly as described in FIG. 4, the STA 810 may determine whether the AP 850 meets an association criteria for establishing a wireless association with the AP 850 based on the AP-related information that is included in the probe response.

At 830, the STA 810 terminates the network scan early without scanning the remaining channels of the first frequency band in response determining that the AP 850 supports communications in both the first channel and the second channel of the first frequency band, and that the AP 850 meets the STA's association criteria for establishing the wireless association with the STA 810.

At 835, the STA 810 sends an association message to the AP 850 to request the establishment of the wireless association between the STA 810 and the AP 850 via either the first channel or the second channel of the first frequency band. For example, the STA 810 may send the association message to the AP 850 via the second channel to request the establishment of the wireless association between the STA 810 and the AP 850 via the second channel.

At 840, the STA 810 and the AP 850 exchange authentication and association related messages in order to establish the wireless association. After the STA 810 and the AP 850 exchange the authentication and association related messages, the wireless association is established and the STA 810 joins the WLAN 100 via the AP 850.

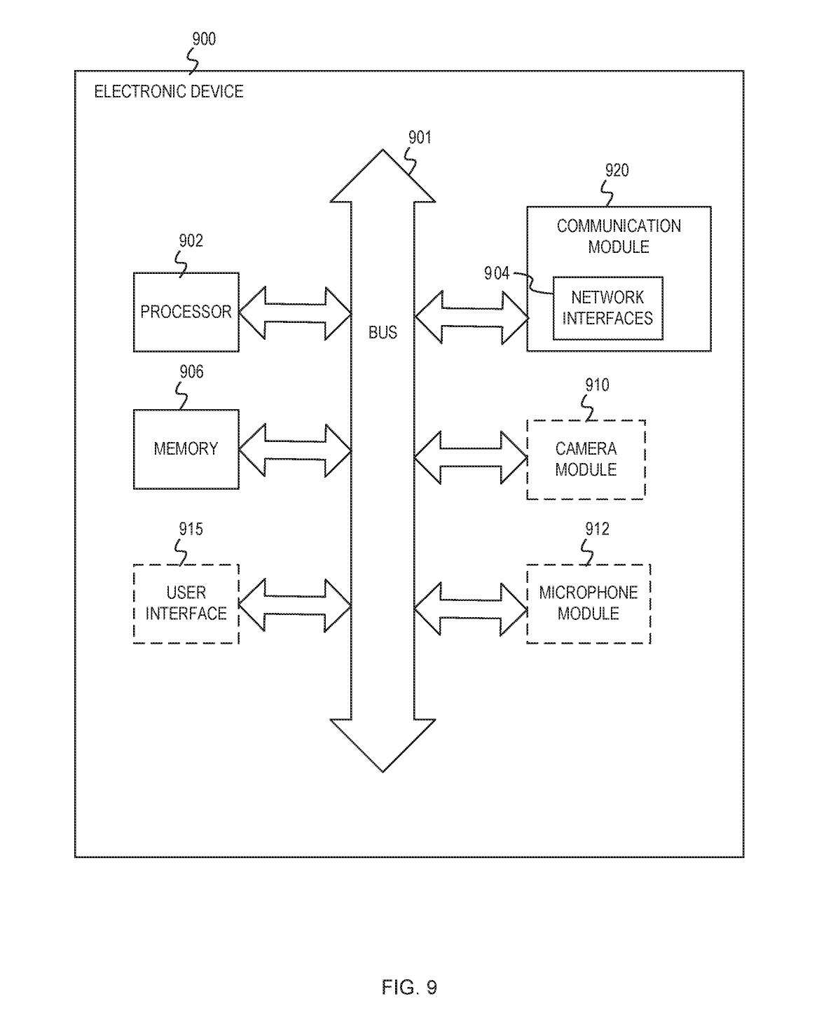

FIG. 9 shows a block diagram of an example electronic device 900 for implementing aspects of this disclosure. In some implementations, the electronic device 900 may be representative of either the STA 110 or the AP 150. The electronic device 900 may be a laptop computer, a tablet computer, a mobile phone, a gaming console, a smartwatch, a wearable device, an access point, a network router, a range extender, or another electronic system. The electronic device 900 includes a processor 902 (possibly including multiple processors, multiple cores, multiple nodes, or implementing multi-threading, etc.). The electronic device 900 includes a memory 906. The memory 906 may be system memory or any one or more of the below-described possible realizations of a machine-readable medium or computer-readable medium. The electronic device 900 also may include a bus 901 (such as PCI, ISA, PCI-Express, HyperTransport®, InfiniBand®, NuBus, AHB, AXI, etc.). The electronic device 900 may include one or more network interfaces 904, that can include at least one of a wireless network interface (such as a WLAN interface, a Bluetooth® interface, a WiMAX® interface, a ZigBee® interface, a Wireless USB interface, etc.) and a wired network interface (such as an Ethernet interface, a powerline communication interface, etc.). In some implementations, the electronic device 900 may support multiple network interfaces 904, each of which may be configured to couple the electronic device 900 to a different communication network.

The electronic device 900 may include a communication module 920. In some implementations, the communication module 920 may include the network interfaces 904. As described in FIG. 1, the network interfaces 904 may be representative of the one or more modems, one or more antennas, analog front end (AFE), and other communication-related components of the electronic device 900.

The memory 906 includes functionality to support various implementations. The memory 906 can include computer instructions executable by the processor 902 to implement the functionality of the implementations described in FIGS. 1-8. For example, the memory 906 may include one or more functionalities that facilitate implementation of the enhanced scanning processes described in FIGS. 1-8. In some implementations, the communication module 920 may perform some or all of the operations described herein. For example, the communication module 920 may include an additional processor (such as a baseband processor) and additional memory that may include computer instructions executable by the additional processor to implement some or all of the functionality of the implementations described in FIGS. 1-8. In some implementations, the additional processor(s) and memory of the communication module 920, the processor 902 and the memory 906, or a combination of some or all of these components can implement the enhanced scanning units, the association units, and the enhanced FTM units described in FIG. 1. In some implementations, the electronic device 900 also may include additional components, such as a camera module 910, a microphone module 912, a user interface 915, and other input/output components. For example, if the electronic device 900 is a STA or is a device that is operating as an AP (such as a software enabled AP or “SoftAP”), the STA may include the camera module 910, the microphone module 912, and the user interface 915. A dedicated or stand-alone AP may include some version of the user interface 915, but may not include the camera module 910 or the microphone module 912.

Any one of these functionalities may be partially (or entirely) implemented in hardware or on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9 (such as video cards, audio cards, additional network interfaces, peripheral devices, etc.). The processor 902, the memory 906, and the communication module 920 may be coupled to the bus 901. Although illustrated as being coupled to the bus 901, the memory 906 may be directly coupled to the processor 902. Furthermore, although illustrated as being within to the communication module 920, in some implementations the network interfaces 904 may be a separate module that is directly coupled to the bus 901.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include cache memory, RAM (including SRAM, DRAM, zero capacitor RAM, Twin Transistor RAM, eDRAM, EDO RAM, DDR RAM, EEPROM, NRAM, RRAM, SONOS, PRAM, or the like), ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for network communication, comprising:
providing, by a station (STA) during a network scan of a first frequency band, a probe request to an access point (AP) of a network via the first frequency band, the probe request indicating the STA supports communications in both the first frequency band and a second frequency band;
receiving, by the STA, a probe response from the AP via the first frequency band;
determining, by the STA based on the probe response received from the AP during the network scan of the first frequency band, whether the AP supports communications in both the first frequency band and the second frequency band; and
determining, by the STA, to terminate the network scan without scanning the second frequency band in response to determining that the AP supports communications in both the first frequency band and the second frequency band.

2. The method of claim 1, further comprising:
determining, by the STA, to establish a wireless association with the AP; and
determining, by the STA, to terminate the network scan without scanning the second frequency band in response to
determining that the AP supports communications in both the first frequency band and the second frequency band, and
determining to establish the wireless association with the AP.

3. The method of claim 1, further comprising:
determining a first operating channel of the AP for the first frequency band and a second operating channel of the AP for the second frequency band from the probe response received from the AP during the network scan of the first frequency band and without scanning the second frequency band; and
establishing a wireless association with the AP via either the first operating channel for the first frequency band or the second operating channel for the second frequency band.

4. The method of claim 3, further comprising:
determining to establish the wireless association with the AP via the second operating channel for the second frequency band; and
establishing the wireless association with the AP via the second operating channel for the second frequency band without having scanned the second frequency band.

5. The method of claim 1, wherein,
the probe request includes a first multi-band indicator that indicates the STA supports communications in multiple frequency bands, the multiple frequency bands including at least the second frequency band in addition to the first frequency band, and
the probe response includes a second multi-band indicator that indicates the AP supports communications in multiple frequency bands and frequency band information that specifies the AP supports communications in both the first frequency band and the second frequency band.

6. The method of claim 5, wherein determining that the AP supports communications in both the first frequency band and the second frequency band is based, at least in part, on determining the probe response includes the second multi-band indicator and determining the frequency band information from the probe response specifies the AP supports communications in both the first frequency band and the second frequency band.

7. The method of claim 1, further comprising:
determining AP-related information from the probe response received from the AP;
determining the AP supports communications in both the first frequency band and the second frequency band based, at least in part, on the AP-related information;
determining the AP-related information meets an association criteria for establishing a wireless association; and
determining to establish the wireless association with the AP in response to determining that the AP-related information meets the association criteria and determining that the AP supports communications in both the first frequency band and the second frequency band.

8. The method of claim 7, wherein the AP-related information includes a media access control (MAC) identifier (ID), a plurality of service set (SS) IDs, AP rates and capabilities, a plurality of frequency bands supported by the AP, and a plurality of operating channels associated with the plurality of frequency bands.

9. The method of claim 1, further comprising:
updating a scan cache with information associated with the second frequency band obtained from the probe response that was received from the AP during the network scan of the first frequency band and without having scanned the second frequency band.

10. The method of claim 1, wherein the probe request indicates the STA also supports communications in a third frequency band, further comprising:
determining the AP supports communications in the third frequency band from the probe response received from the AP;
determining to establish a wireless association with the AP; and
determining to terminate the network scan without scanning the second frequency band and the third frequency band in response to
determining that the AP supports communications in the first frequency band, the second frequency band, and the third frequency band, and
determining to establish the wireless association with the AP.

11. The method of claim 1, further comprising:
receiving, by the STA prior to providing the probe request, a beacon message from the AP via the first frequency band, the beacon message including an indication that the AP supports both the first frequency band and the second frequency band, wherein providing the probe request to the AP via the first frequency band is in response to receiving the beacon message from the AP via the first frequency band.

12. The method of claim 1, further comprising:
determining the probe response includes an indication that the AP supports Fine Timing Measurement (FTM) for optimized wireless local area network (WLAN) positioning of the STA;
determining, by the STA, to perform a WLAN positioning operation with the AP for the STA via the first frequency band; and
determining, by the STA, not to perform the WLAN positioning operation with the AP via the second frequency band.

13. A station (STA), comprising:
a processor; and
memory having instructions stored therein which, when executed by the processor cause the STA to:
provide, during a network scan of a first frequency band, a probe request to an access point (AP) of a network via the first frequency band, the probe request indicating the STA supports communications in both the first frequency band and a second frequency band;
receive a probe response from the AP via the first frequency band;
determine, based on the probe response received from the AP during the network scan of the first frequency band, whether the AP supports communications in both the first frequency band and the second frequency band; and
determine to terminate the network scan without scanning the second frequency band in response to a determination that the AP supports communications in both the first frequency band and the second frequency band.

14. The STA of claim 13, wherein the instructions, when executed by the processor, further cause the STA to:
determine to establish a wireless association with the AP; and
determine to terminate the network scan without scanning the second frequency band in response to
a determination that the AP supports communications in both the first frequency band and the second frequency band, and
a determination to establish the wireless association with the AP.

15. The STA of claim 13, wherein the instructions, when executed by the processor, further cause the STA to:
determine a first operating channel of the AP for the first frequency band and a second operating channel of the AP for the second frequency band from the probe response received from the AP during the network scan of the first frequency band and without scanning the second frequency band; and
establish a wireless association with the AP via either the first operating channel for the first frequency band or the second operating channel for the second frequency band.

16. The STA of claim 15, wherein the instructions, when executed by the processor, further cause the STA to:
determine to establish the wireless association with the AP via the second operating channel for the second frequency band; and
establish the wireless association with the AP via the second operating channel for the second frequency band without having scanned the second frequency band.

17. The STA of claim 13, wherein,
the probe request includes a first multi-band indicator that indicates the STA supports communications in multiple frequency bands, the multiple frequency bands including at least the second frequency band in addition to the first frequency band, and
the probe response includes a second multi-band indicator that indicates the AP supports communications in multiple frequency bands and frequency band information that specifies the AP supports communications in both the first frequency band and the second frequency band.

18. The STA of claim 13, wherein the instructions, when executed by the processor, further cause the STA to:
determine AP-related information from the probe response received from the AP;
determine the AP supports communications in both the first frequency band and the second frequency band based, at least in part, on the AP-related information;
determine the AP-related information meets an association criteria for establishing a wireless association; and
determine to establish the wireless association with the AP in response to a determination that the AP-related information meets the association criteria and a determination that the AP supports communications in both the first frequency band and the second frequency band.

19. The STA of claim 13, wherein the instructions, when executed by the processor, further cause the STA to:
update a scan cache with information associated with the second frequency band obtained from the probe response that was received from the AP during the network scan of the first frequency band and without having scanned the second frequency band.

20. A station (STA), comprising:
means for providing, during a network scan of a first frequency band, a probe request to an access point (AP) of a network via the first frequency band, the probe request indicating the STA supports communications in both the first frequency band and a second frequency band;
means for receiving a probe response from the AP via the first frequency band;
means for determining, based on the probe response received from the AP during the network scan of the first frequency band, whether the AP supports communications in both the first frequency band and the second frequency band;
means for determining, based on the probe response, whether to establish a wireless association with the AP; and
means for determining to terminate the network scan without scanning the second frequency band in response to
determining that the AP supports communications in both the first frequency band and the second frequency band, and
determining to establish the wireless association with the AP.

21. The STA of claim 20, further comprising:
means for determining a first operating channel of the AP for the first frequency band and a second operating channel of the AP for the second frequency band from the probe response received from the AP during the network scan of the first frequency band and without scanning the second frequency band; and
means for establishing the wireless association with the AP via either the first operating channel for the first frequency band or the second operating channel for the second frequency band.

22. The STA of claim 21, further comprising:
means for determining to establish the wireless association with the AP via the second operating channel for the second frequency band; and
means for establishing the wireless association with the AP via the second operating channel for the second frequency band without having scanned the second frequency band.

23. The STA of claim 20, wherein means for determining, based on the probe response, whether to establish the wireless association with the AP further comprises:
means for determining AP-related information from the probe response received from the AP;
means for determining whether the AP supports communications in both the first frequency band and the second frequency band based, at least in part, on the AP-related information;
means for determining whether the AP-related information meets an association criteria for establishing the wireless association; and
means for determining to establish the wireless association with the AP in response to determining that the AP-related information meets the association criteria and determining that the AP supports communications in both the first frequency band and the second frequency band.

24. The STA of claim 20, further comprising:
means for updating a scan cache with information associated with the second frequency band obtained from the probe response that was received from the AP during the network scan of the first frequency band and without having scanned the second frequency band.

25. The STA of claim 20, wherein the probe request indicates the STA also supports communications in a third frequency band, further comprising:
means for determining the AP supports communications in the third frequency band from the probe response received from the AP; and
means for determining to terminate the network scan without scanning the second frequency band and the third frequency band in response to
determining that the AP supports communications in the first frequency band, the second frequency band, and the third frequency band, and
determining to establish the wireless association with the AP.

26. A method for network communication, comprising:
broadcasting, by an access point (AP) of a network, a beacon message to the network via a first frequency band, the beacon message including a first multi-band indicator indicating the AP supports communications in multiple frequency bands;
receiving, by the AP, a probe request from a station (STA) via the first frequency band during a network scan;
determining, by the AP, whether the STA supports communications in multiple frequency bands based on whether the probe request includes a second multi-band indicator indicating the STA supports communications in multiple frequency bands;
generating, by the AP, a probe response that includes the first multi-band indicator and frequency band information specifying the AP supports communications in the first frequency band and a second frequency band in response to determining the STA supports communications in multiple frequency bands; and
providing, by the AP, the probe response to the STA via the first frequency band.

27. The method of claim 26, further comprising:
receiving, by the AP, an association request from the STA via the second frequency band requesting the AP to establish a wireless association with the STA via the second frequency band and without the STA having scanned the second frequency band; and
establishing the wireless association with the STA via the second frequency band.

28. The method of claim 26, wherein the first multi-band indicator is included in a vendor-specific information element of the beacon message and of the probe response, and the second multi-band indicator is included in a vendor-specific information element of the probe request.

29. The method of claim 26, wherein the frequency band information further specifies a first operating channel of the AP for the first frequency band and a second operating channel of the AP for the second frequency band.

30. The method of claim 26, wherein the probe response further includes AP-related information associated with the AP, wherein the AP-related information includes a MAC ID, a plurality of SSIDs, AP rates and capabilities, a plurality of frequency bands supported by the AP, and a plurality of operating channels associated with the plurality of frequency bands.
